(19) United States
(12) Patent Application Publication
(10) Pub. No.: US 2005/0051124 A1
(43) Pub. Date: Mar. 10, 2005

(54) Starter device for an internal combustion engine

(76) Inventors: Roland Adam, Besigheim (DE); Markus Keller, Lohnberg (DE); Stefan Kummermehr, Waiblingen (DE); Heiko Pinkawa, Waiblingen (DE); Jens Kern, Waiblingen (DE); Reinhard Friedrich, Waiblingen (DE)

Correspondence Address: Walter Ottesen;Patent Attorney, P.O. Box 4026, Gaithersburg, MD, 20885-4026, US

(21) Appl. No.: 10/936,574

(22) Filed: Sep. 9, 2004

(30) Foreign Application Priority Data
Sep. 9, 2003 (DE) 103 41 461.4

(51) Int. Cl. F02N 17/00

(52) U.S. Cl. 123/179.1

(57) ABSTRACT

A starter device for an internal combustion engine includes a starter drum which can be coupled to the crankshaft (3) of the engine via at least one catch (13, 23). The catch (23) has at least one pivotally journalled pawl (25) which coacts with an entrainer (19) in a first position (44) and connects the starter drum to the crankshaft (3). In a second position (45) of the pawl (25), the crankshaft (3) and the starter drum are decoupled from each other. A wall (28) is arranged radially outside of the rotational axis (29) of the pawl (25). A gap (34) is formed between the pawl (25) and the wall (28). In order to prevent that the movability of the pawl (25) is negatively affected by dirt collected between the pawl (25) and the wall (28), the width of the gap (34) changes with the pivoting of the pawl (25).

### CROSS REFERENCE TO RELATED APPLICATION

This application claims priority of German patent application no. 103 41 461.4, filed Sep. 9, 2003, the entire content of which is incorporated herein by reference.

### FIELD OF THE INVENTION

The invention relates to a starter device for an internal combustion engine including an internal combustion engine in a portable handheld work apparatus such as a motor-driven chain saw, blower apparatus or the like.

### BACKGROUND OF THE INVENTION

U.S. Pat. No. 5,287,832 discloses a starter device for an internal combustion engine wherein a starter drum is connected to the crankshaft of the engine via a catch. With pulling on the starter rope, the starter drum is connected to the crankshaft and the piston in the cylinder of the engine is moved back and forth because of the rotation. After the end of the stroke on the starter rope, the starter drum is decoupled from the crankshaft via the catch and the starter rope is pulled onto the starter drum. In the region of their support, the pawls of the catch are partially surrounded by a wall. Between the pawls and the wall, dirt can collect which prevents pivoting or makes pivoting of the pawls difficult. A reliable coupling of the starter device to and decoupling from the crankshaft of the engine is then no longer ensured.

### SUMMARY OF THE INVENTION

It is an object of the invention to provide a starter device for an internal combustion engine of the kind described above wherein the starter drum is reliably coupled to the crankshaft and reliably decoupled therefrom.

The starter device of the invention is for an internal combustion engine having a crankshaft defining a crankshaft rotational axis. The starter device includes: a starter drum; an entrainer disposed between the starter drum and the crankshaft; a catch for coupling the starter drum to the crankshaft; the catch including at least one pawl pivotally journalled about a pawl rotational axis; the pawl being movable between a first position wherein the pawl coacts with the entrainer to couple the starter drum to the crankshaft and a second position wherein the pawl decouples the starter drum and the crankshaft from each other; an outer wall arranged radially outside of the pawl rotational axis; the outer wall and the pawl conjointly defining a gap therebetween; and, the gap having a width which changes when the pawl pivots about the pawl rotational axis.

By reducing the gap width, dirt which is present is compressed or pressed out of the gap because of the change of the width of the gap when the pawl is pivoted. With the return pivot of the pawl, dirt present in the gap can loosen and fall out of the gap. The service life of the starter device can be significantly lengthened because of the change of the gap width. The starter device is insensitive to contaminants and the complexity for cleaning the starter device is considerably reduced.

The gap advantageously becomes smaller when the pawl pivots radially outwardly and becomes larger when the pawl pivots radially inwardly. The characterization “radial” refers to the rotational axis of the crankshaft. The pivot movement of the pawl outwardly is caused by centrifugal force. High forces act on the entrainer so that existing dirt is well compressed or can be pressed out of the gap. When the pawl is pivoted back, the forces are significantly less, with these forces being developed, for example, by a return spring. No forces for pressing away the dirt are needed during the return pivot. For this reason, a reliable operation is ensured. Advantageously, the entrainer is mounted radially within the pawl and the pawl is spring loaded in the direction toward the entrainer. The movement of the pawl outwardly is still so supported by the entrainer. The pawl is journalled on a fan wheel which is fixedly connected to the crankshaft so as to rotate therewith.

In order to obtain a good removal of the dirt, the pawl has a convex outer wall in the region of its support and the wall is configured to be concave in the region of the pawl. The gap extends advantageously over at least 60° and especially over more than 120° of the periphery of the pawl in the region of the support. The wall protects the pawl against dirt from the outside and especially from coarse dirt particles. The gap is wider at a first end than at a second end so as to make possible a good removal of the dirt. A changeable gap width can be achieved in a simple manner in that the wall is formed as a circular arc in the region of the support of the pawl. It is practical when the outer wall of the pawl is elliptical and the rotational axis of the pawl lies at the center point of the circular arc of the wall. In this way, a change of the distance between the outer wall of the pawl and the wall in the region of the support results over the pivot movement of the pawl. In order to provide good protection of the pawl, the wall is a peripheral wall and the pawl is mounted radially within the wall. The wall thereby forms a housing wherein the pawl and the entrainer are mounted. The wall is especially arranged on a fan wheel and separates the pawl from the fan vanes.

A reliable connection of the pawl to the entrainer is achieved in that the entrainer has at least one latch recess with which the pawl coacts. Advantageously, the catch has two pawls and four latch recesses. In this way, the rotational path to the next latch recess is kept short. The starter drum is especially a rope drum of a pull-rope starter.

### BRIEF DESCRIPTION OF THE DRAWINGS

The invention will now be described with reference to the drawings wherein:

FIG. 1 is a section view through a starter device according to the invention;

FIG. 2 is an exploded view of a first catch;

FIG. 3 is a plan view of a second catch viewed in the direction of arrow III in FIG. 1;

FIG. 4 is the catch of FIG. 3 with the pawl in a second position; and,

FIG. 5 is a plan view of the entrainer viewed in the direction of arrow V in FIG. 1.

### DESCRIPTION OF THE PREFERRED EMBODIMENTS OF THE INVENTION

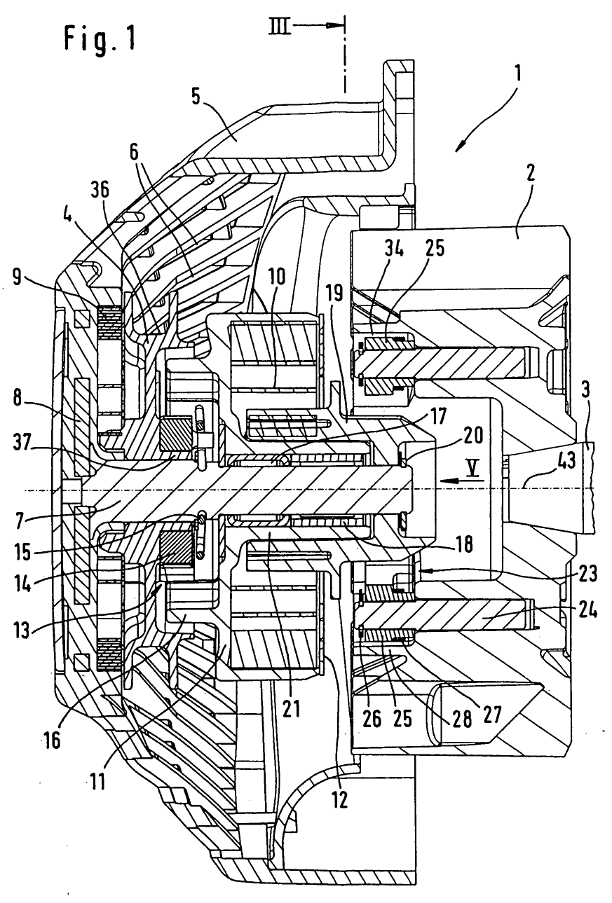

The starter device 1 shown in FIG. 1 serves to start an internal combustion engine and is mounted in a housing 5, especially, in the housing of a portable handheld work apparatus such as a motor-driven chain saw, blower apparatus or the like. The starter device 1 has a rope drum 4 to which rotation is imparted via a pull rope (not shown) which is arranged in a peripheral slot 36 of the rope drum 4. The rope drum 4 is rotatably journalled on a shaft 7 fixed to a housing. The shaft 7 has a base 8 which is cast on the housing 5. The rope drum 4 is connected via a return spring 9 to the housing 5.

A first catch 13 is mounted on the side of the rope drum 4 facing away from the return spring 9. The first catch 13 includes pawls 14 which are pivotally journalled on the rope drum 4. In the direction of the rotational axis 43 of the rope drum 4, the pawls 14 and the rope drum 4 are fixed with a guide clip 15 to the shaft 7. The pawls 14 are mounted on the outer periphery of the hub 37 of the rope drum 4. A collar 16 is arranged radially outside of the pawls 14. The collar 16 extends from a housing 11 of an intermediate spring 10 in the direction toward the rope drum 4. The housing 11 is arranged on the shaft 7 next to the rope drum 4.

The housing 11 is rotatably journalled on the shaft 7 with a needle bearing 17 and a free-running element 18. With the free-running element 18, a rotation of the housing 11 relative to the shaft 7 is possible only in one direction. The housing 11 of the intermediate spring 10 is configured to have a pot shape and is closed by a cover 12 on the side facing away from the rope drum 4. The cover 12 is configured as thin sheet metal.

In the region of the shaft 7, the housing 11 has a flange 21, which extends to the side facing away from the rope drum 4, and the needle bearing 17 and the free-running element 18 are mounted on the inner periphery of the flange 21. An entrainer 19 is rotatably journalled on the outer periphery of the flange 21. The intermediate spring 10 is configured as a spiral spring and is fixed to the housing 11 at a first end thereof and is fixed to the entrainer 19 at a second end thereof. The entrainer 19 is held in axial direction of the shaft 7 by a circlip 20.

The entrainer 19 extends in the region of a fan wheel 2. On the side facing toward the entrainer 19, the fan wheel 2 has a peripherally-extending wall 28 which extends parallel to the rotational axis 43. The rotational axis 43 is the rotational axis of the rope drum 4, the housing 11, the entrainer 19, the fan wheel 2 and the crankshaft 3. Two pawls 25 are pivotally journalled on the fan wheel 2 at the inner periphery of the wall 28. The two pawls 25 and the entrainer 19 conjointly form a second catch 23. The pawls 25 are mounted on bearing bolts 24 and are held in the axial direction of the bearing bolts 24 by circlips 26. The pawls 25 each have a torsion spring 27 with which the pawls are loaded in the direction toward the entrainer 19. A gap 34 is formed between the pawls 25 and the wall 28 in the region of the support of the pawls 25. The fan wheel 2 is fixedly connected to the crankshaft 3 so as to rotate therewith. Vent openings 6 are provided in the housing cover 5 through which the fan wheel 2 draws cooling air and supplies the same to the engine.

For starting the engine, rotation is imparted to the rope drum 4 via the starter rope. The rotational movement is transmitted to the housing 11 of the intermediate spring 10 via the first catch 13. The entrainer 19 is coupled to the crankshaft 3 via the second catch 23. The intermediate spring 10 is tensioned because of the opposing force of the piston and the entrainer 19 comes to a stop. After the first stroke of the starter rope, the rope drum 4 is rotated in the opposite direction by the return spring 9 and the starter rope is again wound onto the rope drum 4. When winding the starter rope, the housing 11 cannot be entrained by the first catch 13 because of the free-running element 18 so that the pawls 25 slide on an edge. In this way, several pull strokes can be repeated during which the intermediate spring 10 is wound more and more. With increasing force of the intermediate spring 10, the piston in the engine is moved via the crankshaft 3 and compresses the air in the combustion chamber of the engine more and more. As soon as the piston has overcome top dead center, the needed force decreases because no further compression is necessary. The intermediate spring 10 relaxes and uniformly rotatingly drives the crankshaft 3. In this way, a reliable start of the engine is ensured. As soon as the fan wheel 2 has reached a certain speed, the pawls 25 of the second catch 23 move outwardly because of the centrifugal force so that the fan wheel 2 is decoupled from the entrainer 19.

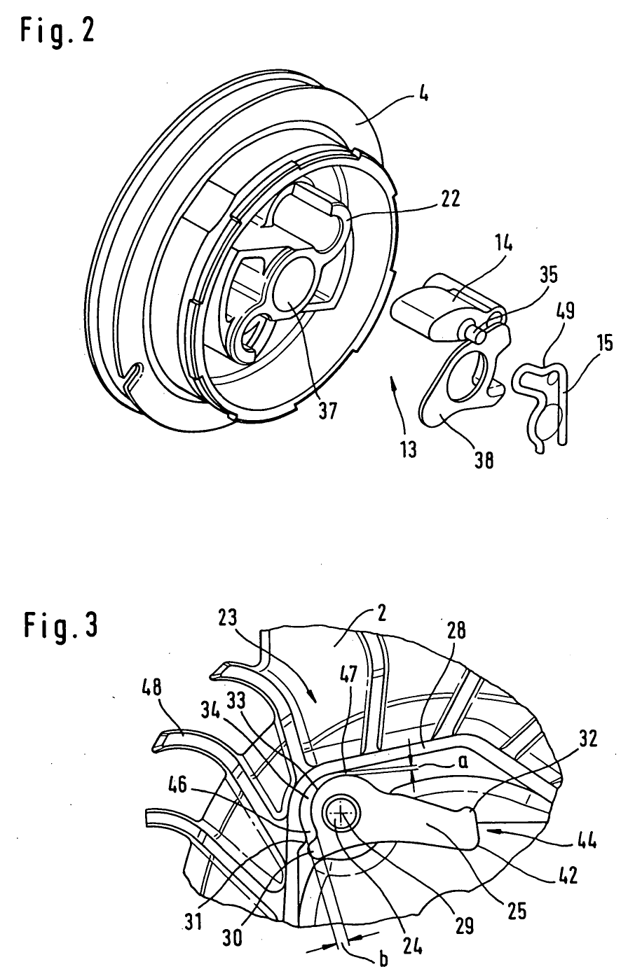

FIG. 2 is an exploded perspective of the first catch 13. The pawl 14 is journalled in the region of a wall 22. The wall 22 surrounds the pawl 14 in the region of its support. Dirt can collect between the wall 22 and the pawl 14 and this dirt hinders the rotational movement of the pawl 14. The gap, which is configured between the pawl 14 and the wall 22, can be so configured that the width of the gap changes during operation with the pivoting of the pawl 14 so that dirt collected in the gap is compressed and is pressed out of the gap. A bolt 35 is arranged on the pawl 14 and this bolt is guided in a guide clip 15. A guide plate 38 is arranged between the pawl 14 and the guide clip 15. The guide plate 38 guides the pawl 14 on its side facing away from the rope drum 4. The guide clip 15 is fixed to the shaft 7 shown in FIG. 1 and holds the pawl 14 in the axial direction via the guide plate 38. The shaft 7 projects through the hub 37 of the rope drum 4. When the pawl 14 pivots outwardly, the bolt 35 moves in the guide clip 15. Because of the shape of the guide clip 15, the pawl 14 must, at first, press with a certain force against the guide clip 15 in order to overcome a bend 49 on the guide clip 15. In this way, the centrifugal force can be adjusted which is necessary in order to pivot the pawl 14 outwardly.

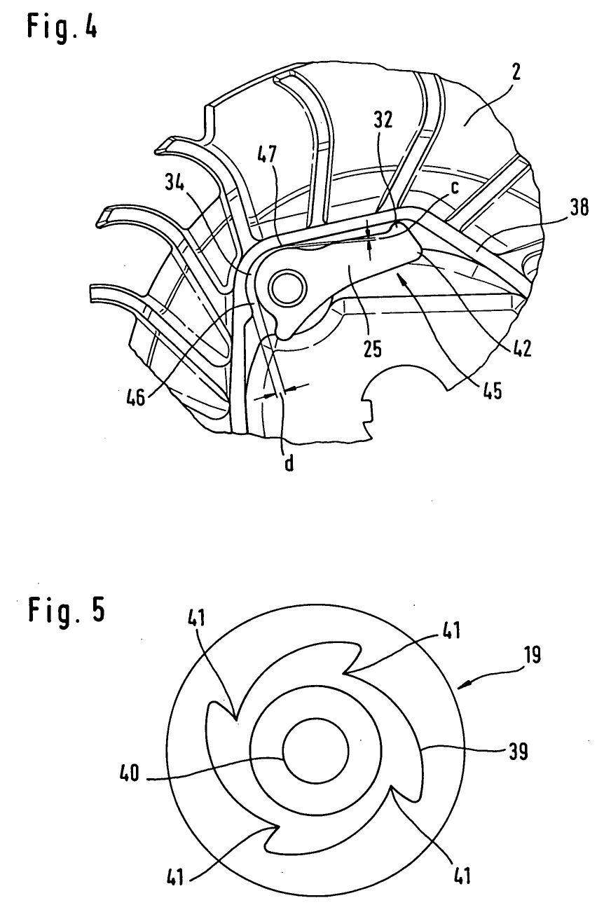

In FIGS. 3 and 4, the pawls 25 of the second catch 23 are shown on the fan wheel 2. In FIG. 3, the pawl 25 is shown in a first position 44. The pawl 25 is pivotally journalled on the bearing bolt 24 about the rotational axis 29. The rotational axis 29 extends parallel to the rotational axis 43 of the crankshaft 3. The rotational axis 29 is arranged radially outside of the rotational axis 43 of the crankshaft 3. The peripheral wall 28 of the fan wheel 2 extends radially outside of the pawl 25. The peripherally-extending wall 28 separates the pawls 25 from the vanes 48 of the fan wheel 2 and so prevents coarse dirt from reaching the region of the pawls 25.

A gap 34 is formed between the wall 28 and the outer wall 33 of the pawl 25. The outer wall 33 of the pawl 25 is formed to be convex in the region of the support and the wall 28 is configured to be concave on the side facing toward the outer wall 33. The gap 34 thereby has an arcuate shape. At a first end 46 of the gap 34, the width (b) of the gap 34 is greater than the width (a) at a second end 47. Advantageously, the width becomes continuously less between the first end 46 and the second end 47. The wall 28 is configured to have the shape of a circular arc and the center point of this arc is the rotational axis 29. The outer wall 33 of the pawl 25 is configured to be elliptical. The distance of the outer wall 33 to the rotational axis 29 becomes less from the first end 46 of the gap 34 to the second end 47. However, it can also be practical that the outer wall 33 of the pawl 25 has the shape of a circular arc in the region of the support and the rotational axis 29 of the pawl 25 is arranged eccentrically to the circular arc of the outer wall 33.

The pawl 25 has a lug 30 in the region of the first end 46 of the gap 34. A first stop 31 is mounted on the wall 28 in the rotational direction of the pawl 25 inwardly, that is, in the clock-wise direction in FIG. 3. The pawl 25 is pressed against stop 31 by the spiral spring 27 shown in FIG. 1 when no entrainer 19 is mounted in the region of the pawl 25. The pawl 25 includes a latch lug 42 which is arranged on the end of the pawl 25 lying opposite the support. The latch lug 42 extends radially inwardly in the direction toward the entrainer 19. On the opposite-lying side facing toward the wall 28, the pawl 25 has a second stop 32 which coacts with the wall 28 and which lies against the wall 28 in the outwardly-pivoted position of the pawl 25.

In FIG. 4, the pawl 25 is shown in its second position 45 wherein the second stop 32 lies against the wall 28. The gap 34 has a width (d) at its first end 46 which is less than the width (b) shown in FIG. 3. On its second end 47, the gap 34 has a width (c) which is likewise less than the width (a) shown in FIG. 3. With the pivoting of the pawl from the first position 44 shown in FIG. 3 outwardly into the second position 45 shown in FIG. 4, the width of the gap 34 becomes smaller. In this way, dirt, which is collected in the gap 34, is compressed and/or is pressed out of the gap 34. The width (a) of the gap 34 can advantageously be between three times to six times as large as the width (c) when the pawl 25 is pivoted outwardly and, for a pawl pivoted inwardly, the width (b) can advantageously amount to approximately 1% to 20% more than the width (d) when the pawl is pivoted outwardly. In this way, a different compression of the dirt collected in the gap results over the length of the gap 34. In this way, the dirt can be pressed out of the gap 34. The width (c) can lie approximately between 0.1 mm and 0.2 mm and the width (d) can lie approximately between 1 mm and 1.5 mm and the width (a) can lie approximately between 0.3 mm and 0.7 mm and the width (b) can lie approximately between 1.2 mm to 1.6 mm.

FIG. 5 shows the entrainer 19 in plan in the direction of arrow V of FIG. 1. The entrainer 19 has a cam contour 39 which, overall, has four latch recesses 41. The latch recesses 41 are arranged rotationally symmetrically to the rotational axis 43. The pawls 25 can latch into the latch recesses 41 with their latch lug 42 and so connect the fan wheel 2 to the entrainer 19 so as to rotate therewith.

It is understood that the foregoing description is that of the preferred embodiments of the invention and that various changes and modifications may be made thereto without departing from the spirit and scope of the invention as defined in the appended claims.

1. A starter device for an internal combustion engine having a crankshaft defining a crankshaft rotational axis, the starter device comprising:
a starter drum;
an entrainer disposed between said starter drum and said crankshaft;
a catch for coupling said starter drum to said crankshaft;
said catch including at least one pawl pivotally journalled about a pawl rotational axis;
said pawl being movable between a first position wherein said pawl coacts with said entrainer to couple said starter drum to said crankshaft and a second position wherein said pawl decouples said starter drum and said crankshaft from each other;
an outer wall arranged radially outside of said pawl rotational axis;
said outer wall and said pawl conjointly defining a gap therebetween; and,
said gap having a width which changes when said pawl pivots about said pawl rotational axis.

2. The starter device of claim 1, wherein said pawl pivots radially outwardly referred to said crankshaft rotational axis and pivots radially inwardly referred to said crankshaft rotational axis when moving between said first and second positions; and, said gap becomes narrower when said pawl pivots radially outwardly and becomes wider when said pawl pivots radially inwardly.

3. The starter device of claim 2, wherein said entrainer is arranged radially within said pawl; and, wherein said starter device further comprises a spring for resiliently biasing said pawl in a direction toward said entrainer.

4. The starter device of claim 3, further comprising a fan wheel fixedly mounted on said crankshaft so as to rotate therewith; and, said pawl being pivotally journalled on said fan wheel.

5. The starter device of claim 4, wherein said pawl has a convex external wall in the region of said pawl rotational axis and said outer wall is concave in the region of said pawl.

6. The starter device of claim 5, wherein said gap extends over at least 60°of the periphery of said pawl in the region of said pawl rotational axis.

7. The starter device of claim 5, said gap extending over more than 120° of the periphery of said pawl in the region of said pawl rotational axis.

8. The starter device of claim 5, wherein said gap has a first end and a second end; and, said gap is wider at said first end than at said second end.

9. The starter device of claim 5, wherein said outer wall has a shape of a circular arc in the region of said pawl rotational axis.

10. The starter device of claim 9, wherein said pawl has an external wall which is configured to be elliptical in the region of said pawl rotational axis and said pawl rotational axis is disposed at the center point of said circular arc of said outer wall.

11. The starter device of claim 10, wherein said outer wall is a peripherally-extending wall and said pawl is arranged radially within said wall.

12. The starter device of claim 4, wherein said fan wheel has vanes; and, said outer wall is arranged on said fan wheel and separates said pawl from said vanes.

13. The starter device of claim 1, wherein said entrainer has a latch recess for coacting with said pawl.

14. The starter device of claim 1, wherein said pawl is a first pawl and said catch includes a second pawl and four latch recesses formed in said entrainer for coacting with said pawls.

15. The starter device of claim 1, wherein said starter drum is a rope drum for a pull-rope starter.
